(19) United States
(12) Patent Application Publication
(10) Pub. No.: US 2024/0273209 A1
(43) Pub. Date: Aug. 15, 2024

(54) FIRMWARE SWITCHING METHOD FOR SYSTEM SECURITY AND ELECTRICAL DEVICE USING THE SAME

(71) Applicant: NUVOTON TECHNOLOGY CORPORATION, HSINCHU CITY (TW)

(72) Inventor: Yung-Chi LAN, Zhubei City (TW)

(21) Appl. No.: 18/406,368

(22) Filed: Jan. 8, 2024

(30) Foreign Application Priority Data
Feb. 14, 2023 (TW) 112105191

(51) Int. Cl. G06F 21/57; G06F 21/55; G06F 21/56

(52) U.S. Cl. CPC G06F 21/572; G06F 21/554; G06F 21/566

(57) ABSTRACT

The present disclosure relates to a firmware switching method for system security and an electrical device using the same. The firmware switching method use a safety protection circuit between the central process unit (CPU) and the security circuit block. When the firmware is updated and malfunction is occurred and the backup firmware is restored, the safety protection circuit is activated to blank the necessary signal for accessing the security circuit block from the CPU. Therefore, even if user made a command to access the security circuit block, the security circuit block is unable to be accessed since the necessary signal is blanked. Thus, even if the firmware is operated at an older version, it also maintains the system security and gives developers more time to modify firmware.

### CROSS-REFFERENCE TO RELATED APPLICATION

This application claims the priority from the Taiwan Patent Application No. 112105191, filed on Feb. 14, 2023, and all contents of this Taiwan Patent Application are incorporated in the present disclosure.

### BACKGROUND OF INVENTION

### 1. Field of Invention

The present invention relates to a firmware updating technique, and more particularly, to a firmware switching method for maintaining system security and an electronic device thereof.

### 2. Related Art

In recent years, the ways of updating the firmware of electronic products tend to allow the consumers to complete updating without the need for returning to the factory settings. However, as there are various ways for the customers to use the products, sometimes errors may occur in the new firmware in certain scenarios, resulting in system abnormity or even making the products ineffective and inoperable, and thus can be difficult to return to the original operable state.

FIG. 1 is a flowchart of a related art method for restoring firmware. Referring to FIG. 1, this firmware restoration method includes:

Step S101: Upgrade the firmware and preserve the backup firmware.

Step S102: Operate with the upgraded firmware.

Step S103: Determine whether there is a firmware error. If there is a firmware error, the flow proceeds to Step S104.

Step S104: Switch to the backup firmware.

When there is no abnormity in the operation of the product, update of the firmware will be executed. On the other hand, when the firmware execution error is detected, the hardware will automatically switch the position of executing the firmware to the backup firmware, so that the firmware is restored to an operable version, and the system can thus operate normally.

In the above-mentioned related art, although the firmware version is allowed to be returned to the user's backup version through the error detection mechanism, so that the user can continue to use the product. However, as far as the security of the product is concerned, it is very dangerous to downgrade the firmware version of the product. This is because the firmware update is usually for fixing the errors occurred in actual use or security loopholes, and the firmware downgrading is equivalent to exposing the product to the risks existing previously.

### SUMMARY

The invention provides a firmware switching method for maintaining system security and an electronic device thereof, to restore the firmware to the backup firmware and switch to an operation mode with limited access, so that the product can continue operating even when a firmware error occurs, and maintain the system security.

The embodiment of the invention provides an electronic device which comprises a storage device, a central processing unit (CPU), a first circuit block, a second circuit block and a security protection circuit. The storage device is used to store a plurality of firmware. The CPU is coupled to the storage device, and outputs a security access signal. The first circuit block is coupled to the CPU. The second circuit block is coupled to the CPU, wherein when the security access signal is in a second state, the second circuit block is allowed to be accessed by the CPU. The security protection circuit is coupled between the CPU and the second circuit block.

When the electronic device updates the plurality of firmware, a first firmware of the storage device is refreshed, and a second firmware is preserved. After the firmware of the electronic device is updated, the updated first firmware is operated. When the first firmware is unable to be operated, the first firmware is switched to the second firmware, and the security protection circuit is activated to enter a security mode. When the security protection circuit is activated, the security access signal received by the second circuit block is set to a first state.

According to a preferred embodiment of the present invention, the security protection circuit comprises an error detection circuit and a first logic gate. The error detection circuit is used to detect an operation error to determine whether to enter the security mode. The first logic gate includes a first end, a second end and an output end, wherein the first end of the first logic gate receives the security access signal outputted by the CPU, the second end of the first logic gate is coupled to the error detection circuit, and the output end of the first logic gate is coupled to the second circuit block. When the error detection circuit enters the security mode, the second end of the first logic gate receives a preservation signal outputted by the error detection circuit, and the output end of the first logic gate outputs the security access signal of the first state. In a preferred embodiment of the present invention, the first logic gate is an OR gate, and the preservation signal outputted by the error detection circuit is a logic-high voltage. In another preferred embodiment of the present invention, the first logic gate is a multiplexer, the second terminal and the selection control terminal of the multiplexer receive the preservation signal outputted by the error detection circuit, and when the preservation signal outputted by the error detection circuit is a logic-high voltage, the output terminal of the multiplexer outputs a logic-high voltage.

According to a preferred embodiment of the present invention, the second circuit block is an attack detection circuit, and the CPU cannot turn off the attack detection circuit when the security mode is entered.

Another embodiment of the present invention provides a firmware switching method for maintaining system security for protecting an electronic device. The firmware switching method comprises following steps: arranging a security protection circuit between a central processing unit and a security circuit block, wherein when a security access signal outputted by the CPU is detected to be in a second state, the security circuit block is allowed to be accessed; updating the electronic device with a first firmware, and preserving a second firmware; after the firmware of the electronic device is updated, operating with the updated first firmware; when the first firmware is unable to be operated, switching from the first firmware to the second firmware, and enabling the security protection circuit to enter a security mode; and when the security protection circuit is activated, setting, by the security protection circuit, the security access signal received by the security circuit block to a first state.

To sum up, the spirit of the embodiments of the present invention resides in setting a security protection circuit between the CPU and the security circuit block of an electronic equipment. When the old firmware is unable to be used and restored due to updating the firmware, the security protection circuit is activated and the signals required for the CPU to access the security circuit block are shielded. Therefore, even if the user inputs a command, the security circuit block is unable to be accessed because the signals are shielded. Therefore, the system security can be ensured even if the firmware remains at the older version, thus giving the developer more time to modify the firmware.

In order to further understand the techniques, approaches and effects of the present invention, reference can be made to the following detailed description and drawings, so that the purposes, features and concepts of the present invention can be thoroughly and concretely understood. However, the following detailed description and drawings are merely for reference to illustrate the implementation of the present invention, rather than limiting the scope of the present invention.

### BRIEF DESCRIPTION OF DRAWINGS

The accompanying drawings are provided for those skilled in the art to further understand the present invention, and are incorporated into and constitute a part of the specification of the present invention. The accompanying drawings illustrate exemplary embodiments of the invention and together with the description of the invention serve to explain the principles of the invention.

FIG. 1 is a flowchart illustrating a related art firmware restoration method.

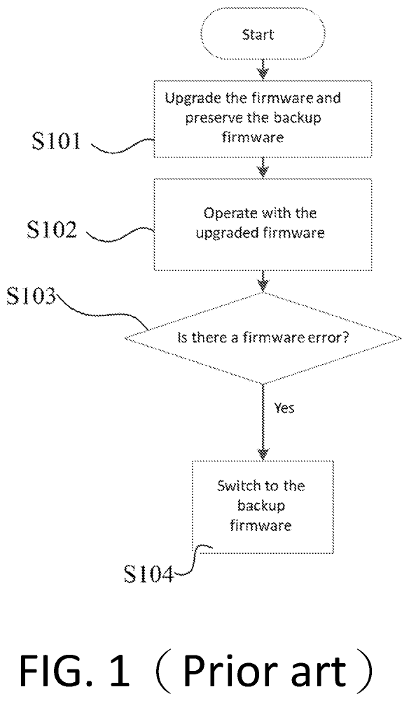

FIG. 2 is a circuit block diagram of an electronic device according to a preferred embodiment of the present invention.

FIG. 3 is a circuit block diagram of an electronic device according to another preferred embodiment of the present invention.

FIG. 4 is a circuit block diagram of an electronic device according to yet another preferred embodiment of the present invention.

FIG. 5 is a flowchart illustrating a firmware switching method for maintaining system security according to a preferred embodiment of the present invention.

### DESCRIPTION OF PREFERRED EMBODIMENTS

Reference can be made in detail to exemplary embodiments of the present invention, which are illustrated by the accompanying drawings. In possible circumstances, the same symbol used in the drawings and the description represent same or similar elements. In addition, the practices of the exemplary embodiments are only part of the implementations of the entire design concept of the present invention, and the following exemplary embodiments are not used to limit the scope of the present invention.

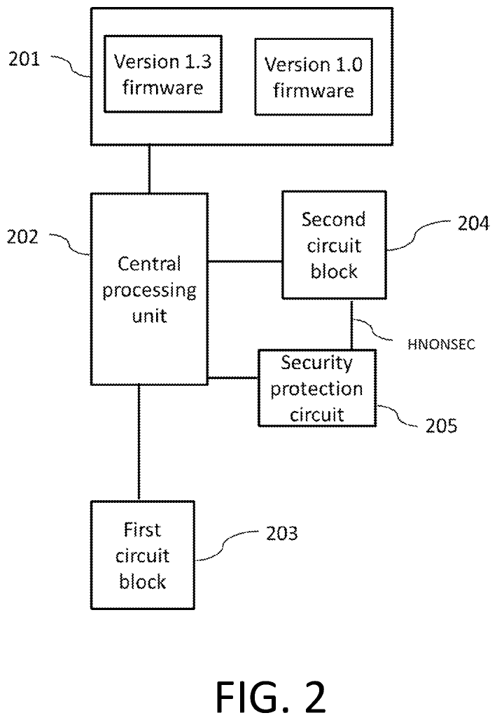

FIG. 2 is a circuit block diagram of an electronic device according to a preferred embodiment of the present invention. Please refer to FIG. 2, the electronic device comprises a storage device 201, a central processing unit 202, a first circuit block 203, a second circuit block 204 and a security protection circuit 205. The storage device 201 is used to store firmware and is implemented in the form of flash memory in the preferred embodiment. However, those skilled in the art should be readily to know that erasable programmable read-only memory (EPROM) or electronically erasable rewritable read-only memory (EEPROM) can also be used a storage device 201 for storing firmware, and the present invention is not limited to the above. Generally, the CPU 202 controls other peripheral circuit blocks according to the firmware in the storage device 201 and the user's operation. In this embodiment, the first circuit block 203 is illustrated as a security-irrelevant circuit block, while the second circuit block 204 is illustrated as a security circuit block. The security protection circuit 205 is coupled between the CPU 202 and the second circuit block 204.

To highlight the spirit of the present invention, in this embodiment, the CPU 202 is authorized by an Advanced RISC Machine (ARM), and the CPU 202 has a TrustZone function. The CPU 202 with this function may use the security access signal HNONSEC to represent the operating state of the CPU 202, wherein the security access signal HNONSEC is a signal sent by the CPU 202 to the accessed circuit block. If the current operation state of the CPU 202 is secure, the security access signal HNONSEC will be set to a logic-low voltage. If the current operating state of the CPU 202 is non-secure, the security access signal HNONSEC will be set to a logic-high voltage. The accessed circuit block will be based on the status of the security access signal HNONSEC sent to it by the CPU 202. In this embodiment, the first circuit block 203 is illustrated as a security-irrelevant circuit block, and the second circuit block 204 is illustrated as a security circuit block. Therefore, the second circuit block 204 must detect that the security access signal HNONSEC is set to a logic low voltage before being accessed by the central processing unit 202.

In general, the storage device 201 is divided into two blocks, e.g., the first flash memory block 21 and the second flash memory block 22. In this embodiment, for example, the first flash memory block 21 is used to store a Version 1.0 firmware, and the second flash memory block 22 is used to store a Version 1.3 firmware. Therefore, in this embodiment, the firmware Version 1.3 is considered as a newer firmware, and the firmware Version 1.0 is considered a backup firmware. As the Version 1.3 firmware works normally, the backup Version 1.0 firmware will not be used.

Assumed that the vendor has released a Version 2.0 firmware. When a user operates the electronic device and receives a firmware update message of the Version 2.0 firmware through Over the Air (OTA), and the user decides to update to the Version 2.0 firmware, the Version 2.0 firmware will be fed-in to the first flash memory block 21 to replace the Version 1.0 firmware, and the Version 1.3 firmware in the second flash memory block 22 will be set as a backup firmware. When the firmware of the electronic device is updated to Version 2.0, the system will reboot and operate with the Version 2.0 firmware. During operating of the updated Version 2.0 firmware, if the operation is normal, the system continues operating with the Version 2.0 firmware. However, in this embodiment, if an error occurs during the operation of the firmware Version 2.0, the firmware must be restored to the backup firmware (e.g., the Version 1.3 firmware). The firmware Version 2.0 is actually used to fix the loopholes existing in the firmware Version 1.3. In this embodiment, when the firmware is switched from Version 2.0 to Version 1.3, the security protection circuit 205 will be activated to enter a security mode. When the security protection circuit 205 is activated, the security access signal HNONSEC received by the second circuit block 204 is set to a logic-high voltage. Therefore, even if a user operates this electronic device, the CPU 202 is unable to access the second circuit block 204, because the security access signal HNONSEC received by the second circuit block 204 is set to a logic-high voltage, thereby ensuring the security of this electronic device.

In the above embodiment, because the security access signal HNONSEC is set to a logic-high voltage, the first circuit block 203 which is security irrelevant is allowed to be accessed or operated. Therefore, the electronic device is set to maintaining basic functions, but some functions that are sensitive or relevant to security loopholes are forbidden from being accessed. For example, when errors are detected the firmware of a vehicle with an auto-drive function, the vehicle will be forcefully switched and pulled over to the shoulder of the road or a safe area, and a prompt is generated to notify the driver that the vehicle is turning to the manual driving mode. Meanwhile, as the CPU 202 is unable to access the second circuit block 204, all the functions that could have been controlled by the driving computer, such as braking, throttle, steering wheel, etc., which would be dangerous due to the loopholes, are stopped. In addition, since the first circuit block 203 which is security-irrelevant is normally accessed and operated, the vehicle can still be operated. As all the functions that may be harmful due to the loopholes are turned off in advance, this safe firmware mode has many limitations. However, the firmware programmer may base on the product characteristics to design a firmware with basic functions without jamming the system. When a new version of firmware is released, the firmware update function is published, so that the new firmware can be updated as soon as it is released.

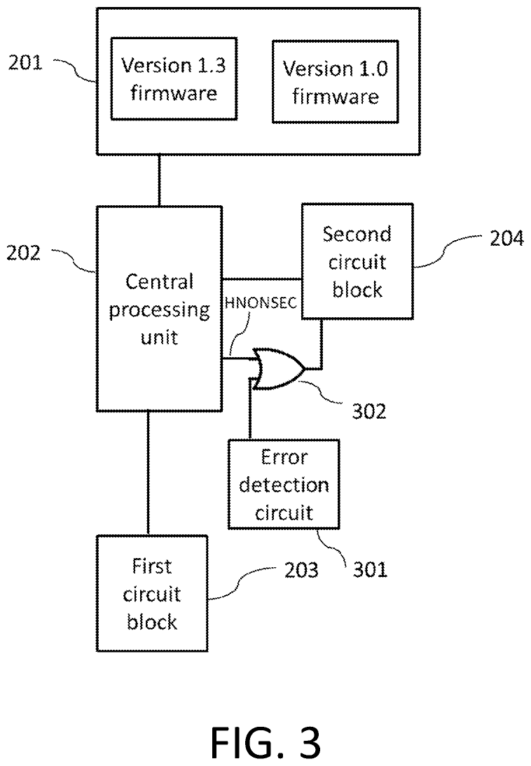

FIG. 3 is a circuit block diagram of an electronic device according to another preferred embodiment of the present invention. Please refer to FIG. 3, the security protection circuit 205 in this embodiment may be implemented an error detection circuit 301 and a logic OR gate 302. The error detection circuit 301 is used to detect an operation error, to determine whether to enter the above-mentioned security mode. Before the error detection circuit 301 enters the security mode, the signal output to the logic OR gate 302 is maintained at a logical low voltage. Therefore, when the security access signal HNONSEC outputted by the CPU 202 is a logic-high voltage, the logic OR gate 302 outputs a logic-high voltage to the second circuit block 204. Similarly, when the security access signal HNONSEC outputted by the CPU 202 is a logic-low voltage, the logic OR gate 302 outputs a logic-low voltage to the second circuit block 204.

Similar to the above embodiment, after the firmware is switched to the backup firmware due to wrongful operations, the error detection circuit 301 will enter the safe mode. When the error detection circuit 301 enters the safe mode, the signal outputted to the logic OR gate 302 is locked at a logic-high voltage. At this time, whether the security access signal HNONSEC outputted by the CPU 202 is a logic-high voltage or a logic-low voltage, the logic OR gate 302 outputs a logic-high voltage to the second circuit block 204. In other words, when the security protection circuit is activated, the security access signal HNONSEC received by the second circuit block 204 is a logic-high voltage. Therefore, the second circuit block 204 is unable to be accessed by the CPU 202.

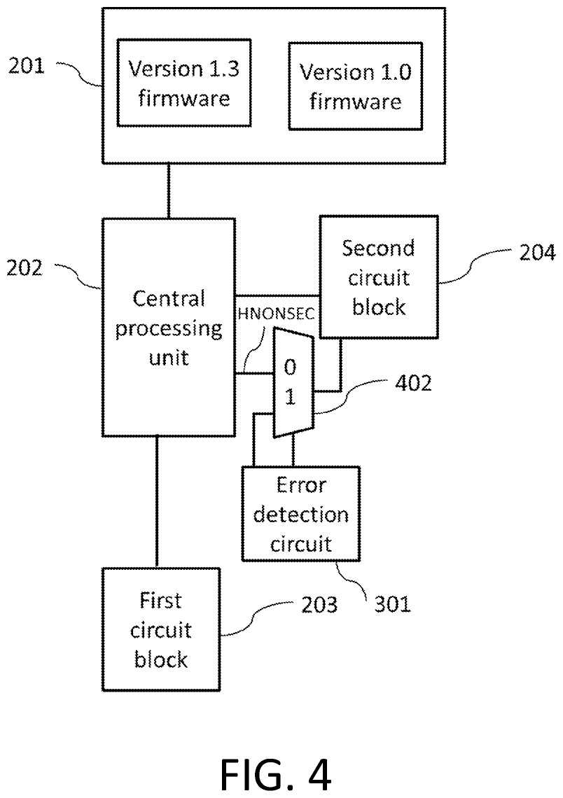

FIG. 4 is a circuit block diagram of an electronic device according to yet another preferred embodiment of the present invention. Please refer to FIG. 4. the security protection circuit 205 in this embodiment is implemented by an error detection circuit 301 and a multiplexer 402. Similarly, the error detection circuit 301 is used to detect an operation error, to determine whether to enter the above-mentioned security mode. Before the error detection circuit 301 enters the safe mode, the signal output to the multiplexer 402 is maintained at a logic-low voltage. Meanwhile, the multiplexer 402 will directly connect the security access signal HNONSEC outputted by the CPU 202 to the output end of the multiplexer 402, and the second circuit block 204 can directly receive the security access signal HNONSEC outputted by the CPU 202. As a result, the CPU 202 may operate the second circuit block 204 in this mode.

When the error detection circuit 301 enters the safe mode, the signal output to the multiplexer 402 is locked at a logic-high voltage. Meanwhile, the end of the multiplexer 402 coupled to the error detection circuit 301 will be coupled to the output of the multiplexer 402. No matter the security access signal HNONSEC outputted by the CPU 202 is a logic-high voltage or a logic-low voltage, the multiplexer 402 will output a logic-high voltage to the second circuit block 204. In other words, as long as the security protection circuit is activated, the security access signal HNONSEC received by the second circuit block 204 is a logic-high voltage. Therefore, the second circuit block 204 is unable to be accessed by the CPU 202.

Although the above embodiments mainly prevent the second circuit block 204 from being accessed, but may also prevent the security circuit from being turned off when in practice. For example, some products have a circuit with a tamper power domain, and this tamper power domain will be provided with some circuits for detecting attacks. Some consumers may turn off this function to save electricity. e.g., a user may power off the tamper power domain via the firmware control to achieve the goal of saving electricity. However, when the aforementioned embodiments of the present invention are applied to enter the security mode, the tamper power domain will be forcefully activated and unable to be turned off.

Although in the above embodiment, two circuit blocks 203 and 204 are illustrated, but those skilled in the art should be readily to know that the number of circuit blocks may vary with different products. And according to the complexity of the product, the circuit blocks used for security may also increase. Furthermore, in the above embodiment, although the CPU of the Advanced RISC Machine (ARM) and the security access signal HNONSEC are illustrate in a preferred embodiment, those skilled in the art should be readily to know that when the CPU changes, the security access signal may change along, and the state of the accessible logic voltage may also change. Therefore, as long as a security protection circuit is arranged between the circuit block for security and the CPU, after the firmware is restored, it enters the protection mode to shield the security access signal, so that the CPU is unable to access the circuit block. Any modification meets the above approach falls within the scope of the present invention, and the present invention is not limited to the above embodiments.

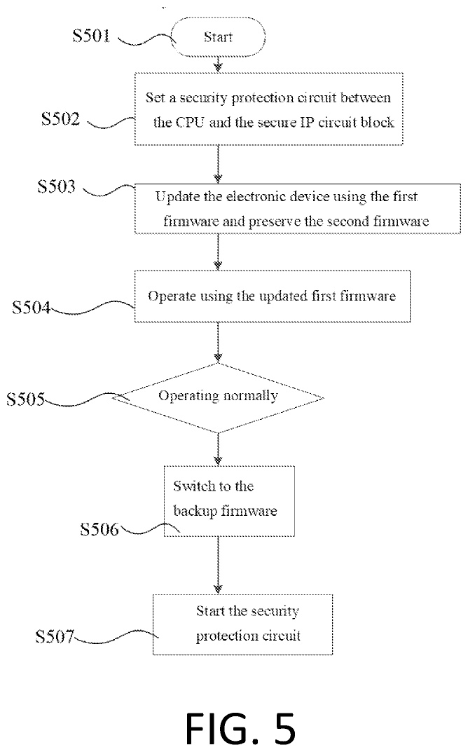

From the above embodiments, a firmware switching method for maintaining system security is summarized. FIG. 5 is a flowchart illustrating a firmware switching method for maintaining system security according to a preferred embodiment of the present invention. Referring to FIG. 5, the firmware switching method for maintaining system security comprises the following steps:

Step S501: Start.

Step S502: Set a security protection circuit between the CPU and the secure circuit block. In this embodiment, the security circuit block may be the second circuit block 204 described previously. Therefore, the output security access signal must be set to a logic-low voltage before the second circuit block 204 can be accessed by the CPU.

Step S503: Update the electronic device using the first firmware and preserve the second firmware. As described in the above embodiments, for example, the location where Version 1.0 firmware is stored will be refreshed and replaced with Version 2.0 firmware, and Version 1.3 firmware is preserved for backup.

Step S504: Operate using the updated first firmware. As described in the above embodiment, when the firmware of the electronic device is updated, the new Version 2.0 firmware is used for operation.

Step S505: Determine whether the first firmware is operating normally. When the operation is abnormal, the flow proceeds to Step S506.

Step S506: Switch from the first firmware to the second firmware. As described in the above embodiments, when the Version 2.0 firmware cannot run, the firmware is switched to the Version 1.3 firmware.

Step S507: Start the security protection circuit to enter the security mode. As described in the above embodiment, when the security protection circuit is activated, the security protection circuit sets the security access signal received by the second circuit block 204 (i.e., the security circuit block) to a logic-high voltage. Similarly, although the above embodiment uses logic-high voltage as an example, those skilled in the art should readily know that the state of the security access signal may vary with the CPU. Therefore, the logic-high voltage, logic-low voltage or other high impedance states are design choices of designers, the invention does not further limit on that.

To sum up, the spirit of the embodiments of the present invention resides in setting a security protection circuit between the CPU and the security circuit block of an electronic equipment. When the old firmware cannot be used and restored due to updating the firmware, the security protection circuit is activated, and the signals required for the CPU to access the security circuit block are shielded. Therefore, even if the user inputs a command, the security circuit block is unable to be accessed because the signals are shielded. Therefore, the system security can be ensured even if the firmware remains at the older version, thus giving the developer more time to modify the firmware.

It should be understood that the examples and embodiments described in the context are for illustrative purposes only, and various modifications or changes adopted by those skilled in the art are comprised within the spirit and scope of the present invention and the appended claims.

What is claimed is:

1. An electronic device comprising:
a storage device configured to store a plurality of firmware;
a central processing unit (CPU) coupled to the storage device and configured to output a security access signal;
a first circuit block coupled to the CPU;
a second circuit block coupled to the CPU, wherein when the security access signal is in a second state, the second circuit block is allowed to be accessed by the CPU; and
a security protection circuit coupled between the CPU and the second circuit block, wherein:
when the electronic device updates the plurality of firmware, a first firmware of the storage device is refreshed, and a second firmware is preserved;
after the firmware of the electronic device is updated, the updated first firmware is operated;
when the updated first firmware is unable to be operated, the first firmware is switched to the second firmware, and the security protection circuit is activated to enter a security mode; and
when the security protection circuit is activated, the security access signal received by the second circuit block is set to a first state.

2. The electronic device according to claim 1, wherein the security protection circuit comprises:
an error detection circuit configured to detect an operation error to determine whether to enter the security mode; and
a first logic gate including a first end, a second end and an output end, wherein the first end of the first logic gate receives the security access signal outputted by the CPU, the second end of the first logic gate is coupled to the error detection circuit, and the output end of the first logic gate is coupled to the second circuit block.
wherein when the error detection circuit enters the security mode, the second end of the first logic gate receives a preservation signal outputted by the error detection circuit, and the output end of the first logic gate outputs the security access signal of the first state.

3. The electronic device according to claim 2, wherein the first logic gate is an OR gate, and the preservation signal outputted by the error detection circuit is a logic-high voltage.

4. The electronic device according to claim 2, wherein the first logic gate is a multiplexer, and the second end and a selection control end of the multiplexer receive the preservation signal outputted by the error detection circuit, and when the preservation signal outputted by the error detection circuit is a logic-high voltage, the output end of the multiplexer outputs a logic-high voltage.

5. The electronic device according to claim 1, wherein the second circuit block is an attack detection circuit, and when the security mode is entered, the CPU is unable to turn off the attack detection circuit.

6. A firmware switching method for maintaining system security for protecting an electronic device, comprising:
arranging a security protection circuit between a central processing unit and a security circuit block, wherein when a security access signal outputted by the CPU is detected to be in a second state, the security circuit block is allowed to be accessed;
updating the electronic device with a first firmware, and preserving a second firmware;
after the firmware of the electronic device is updated, operating with the updated first firmware;
when the first firmware is unable to be operated, switching from the first firmware to the second firmware, and enabling the security protection circuit to enter a security mode; and
when the security protection circuit is activated, setting, by the security protection circuit, the security access signal received by the security circuit block to a first state.

7. The firmware switching method for maintaining system security according to claim 6, wherein the security protection circuit comprises:
an error detection circuit for detecting an operation error, to determine whether to enter the security mode; and
a first logic gate including a first end, a second end and an output end, wherein the first end of the first logic gate receives the security access signal outputted by the CPU, the second end of the first logic gate is coupled to the error detection circuit, and the output end of the first logic gate is coupled to the security circuit block;
wherein when the error detection circuit enters the security mode, the second end of the first logic gate receives a preservation signal outputted by the error detection circuit, and the output end of the first logic gate outputs the security access signal of the first state.

8. The firmware switching method for maintaining system security according to claim 7, wherein the first logic gate is an OR gate, and the preservation signal outputted by the error detection circuit is a logic-high voltage.

9. The firmware switching method for maintaining system security according to claim 7, wherein the first logic gate is a multiplexer; and the second end and the selection control end of the multiplexer receive the preservation signal outputted by the error detection circuit, and when the preservation signal outputted by the error detection circuit is a logic-high voltage, the output end of the multiplexer outputs a logic-high voltage.

10. The firmware switching method for maintaining system security according to claim 6, wherein the security circuit block is an attack detection circuit, and when the security mode is entered, the CPU cannot turn off the attack detection circuit.
